(19) United States
(12) Patent Application Publication
(10) Pub. No.: US 2011/0180673 A1
(43) Pub. Date: Jul. 28, 2011

(54) TAKING OFF AND LANDING AIRPLANE USING VARIABLE ROTARY WINGS

(76) Inventor: Chaeho Lim, Hamyang-gun (KR)

(21) Appl. No.: 13/122,436

(22) PCT Filed: Nov. 6, 2008
(86) PCT No.: PCT/KR2008/006548

§ 371 Date: Apr. 4, 2011

(30) Foreign Application Priority Data
Oct. 4, 2008 (KR) 10-2008-0097452

(51) Int. Cl. B64C 27/22; B64C 29/00

(52) U.S. Cl. 244/7 A

(57) ABSTRACT

This invention is regarding a VTOL aircraft that is designed to enable it to take off by generating lift through rotary wings like a helicopter and then moving forward; and when it flies at high speeds, it is able to use jet engines so that it can generate lift through fixed wings while the rotary wings are transformed into fixed wings to generate lift by adjusting the angles between the individual wings thereby enhancing the efficiency.

### TECHNICAL FIELD

This invention is regarding a VTOL aircraft using variable rotary wings that would take off vertically by generating lift using the rotary wings; fly forward at high speeds with the thrust generated using jet engines while adjusting the angles between each of the rotary wings to make them into a form of fixed wings that can efficiently generate lift

### BACKGROUND ART

Not only in Korea, where a great deal of the area is composed of mountains which poses a lot of trouble in constructing airfields, but also many other countries have insufficient numbers of airfields and the existing airfields are located far away from residential areas due to the great amounts of noise generated by airplanes, so not only have there been a lot of difficulties for small-to-medium sized groups or individuals in attempting to depart from places in the vicinity of their houses or work places and directly move to the desired destinations using airplanes without wasting precious time and energy; or for people in attempting to go into dangerous areas; or for military corps in attempting to move fast to locations for operations and vertically take off or land in order to execute operations, but also there have been a lot of problems involving accidents and the loss of human lives created by the existing VTOL airplanes due to their lack of safety caused by the unstability of the air current created when their rotary wings have been turned 90° anteriorly. Also, since the maximum speed of a normal VTOL is limited to 500-600 km/h under current technologies. Flight speed is very important to people who need to reach their destination quickly, such as businessmen with deadlines or people who are exhausted by long flights, but many difficulties and problems occur when attempting to obtain higher speeds.

### DISCLOSURE OF THE INVENTION

### Technical Problem

The purpose of this invention is to enable a VTOL aircraft to safely change the form of its rotary wings while flying at high speeds in order to eliminate the danger that occurs when they attempt to transform from a VTOL aircraft into a fixed propeller wing-type aircraft for flying by turning their rotary wings 90° anteriorly due to the danger caused by the instability of the air current generated around the propellers or to relieve the inconvenience of them being unavoidably slower than aircraft that use jet engines since their maximum speed is limited to 500-600 km/h under current technologies.

### Technical Solution

In order to achieve the above mentioned purpose, this invention is comprised of rotary wings with built-in drive motors that enable the body of the wings and the flying body of the VTOL aircraft to generate lift when vertically taking-off/landing and to efficiently generate lift when flying at high speeds by transforming the aircraft into a fixed propeller-type aircraft; in addition to the installation of a jet engine that will generate thrust when flying at high speeds.

### Advantageous Effects

As mentioned above, the Vertical Take-Off and Land aircraft (VTOL) with variable rotary wings generates lift like a rotary winged aircraft when taking off and moves forward like a helicopter, so it is capable of launching from roads, buildings, parking lots, ship decks, and other flat surfaces; and, when it is necessary to fly at high speeds, it has a jet engine that produces thrust while the pilot adjusts the wing spread then fixes the wings in place using the built-in driving gear with a controlling device. When the aircraft flies at a high speed in this form, if the existing rotary wings are turned by 90°, which transforms the aircraft into a fixed-propeller winged aircraft, the aircraft may drop due to the unstability of the air streams generated around the propellers; thus to remove the problem of increased danger caused by the unsafe conditions, if the aircraft uses the rotary wings when taking off vertically, and the swash plates are tilted forward, thrust will be produced as the vertical lift produced by the rotary wings is redirected to create thrust which will push the aircraft forward at a low speed; and when high speeds are needed, if the air craft uses the jet engine to generate thrust and makes the rotary wings to have the form of spread eagle wings that can produce lift by controlling the servo motor using a controlling device. This is necessary because, if the existing rotary wings that can generate lift and thrust are left in the same position when the aircraft flies at a high speed, the lifts on the two sides of the aircraft may not be balanced and may generate drag since the angles of the rotary wings attached to the farthest ends of both sides of the aircraft may be different so that the rotary wings can add thrust after they are in the fixed-wing position in order to balance the lifts of the fixed rotary wings on both sides of the aircraft; then the risk of dropping due to the sudden loss of speed cause when the rotary wings are turned toward the flying direction may be removed; thus stability can be guaranteed for the VTOL, which has been mainly utilized as military aircraft due to the existing instability. This stability will make it possible to utilize the VTOL as a civil aircraft, and will also allow the craft to fly at super-sonic speeds, which far exceeds the maximum speed of a normal VTOL, which is limited to 500-600 km/h, and thus this invention will have a variety of uses.

### BRIEF DESCRIPTION OF DRAWINGS

FIG. 1 is a diagonal view of a VTOL airplane with variable rotary wings as it takes off vertically,

FIG. 2 is a diagonal view of the major parts of the variable rotary wings,

FIG. 3 is an illustration of the a diagonal view of the variable rotary wings with its major parts cut off

FIG. 4 is an illustration of a flat view of the variable rotary wings with its major parts cut off,

FIG. 5 is a front view of the cut driving shaft with a built-in receiver, control device and servo motor,

FIG. 6 is a flat view of the adjusted variable rotary wings,

FIG. 7 is a diagonal view of the adjusted variable rotary wings,

FIG. 8 is a diagonal view of the variable rotary wings in the fixed-wing position,

FIG. 9 is a diagonal view of the VTOL airplane with variable rotary wings when vertically taking off,

FIG. 10 is a diagonal view of major parts of the variable rotary wings,

FIG. 11 is an illustration of the diagonal view of the variable rotary wing its major parts cut off,

FIG. 12 is an illustration of the flat view of the variable rotary wings with its major parts cut off,

FIG. 13 is a front view of the cut receiver, control device, and servo motor,

FIG. 14 is a flat view of the adjusted variable rotary wings,

FIG. 15 is a diagonal view of the adjusted variable rotary wings,

FIG. 16 is a diagonal view of the variable rotary wings in the fixed-wing position,

FIG. 17 is a diagonal view of a VTOL airplane using the variable rotary wings to land vertically.

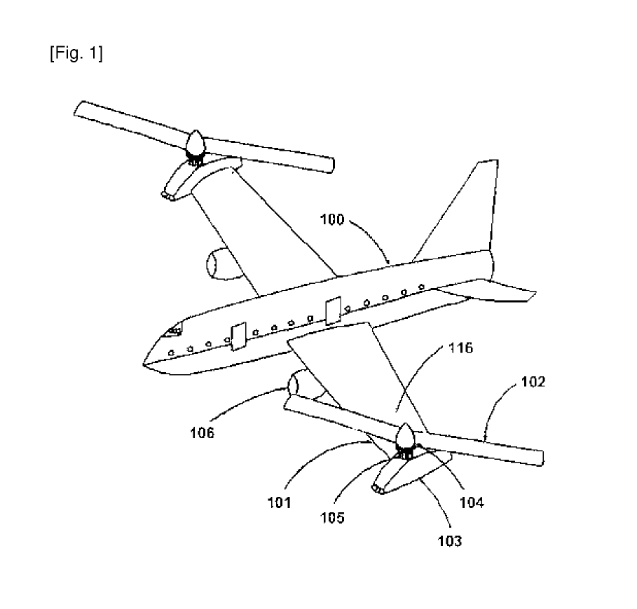

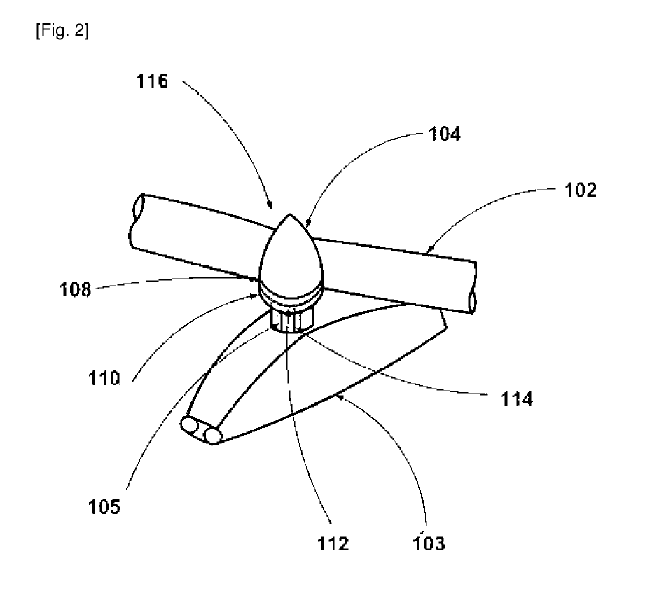

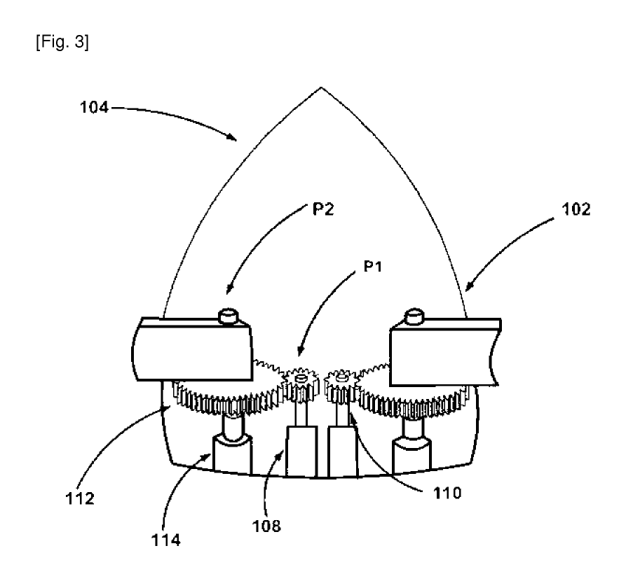

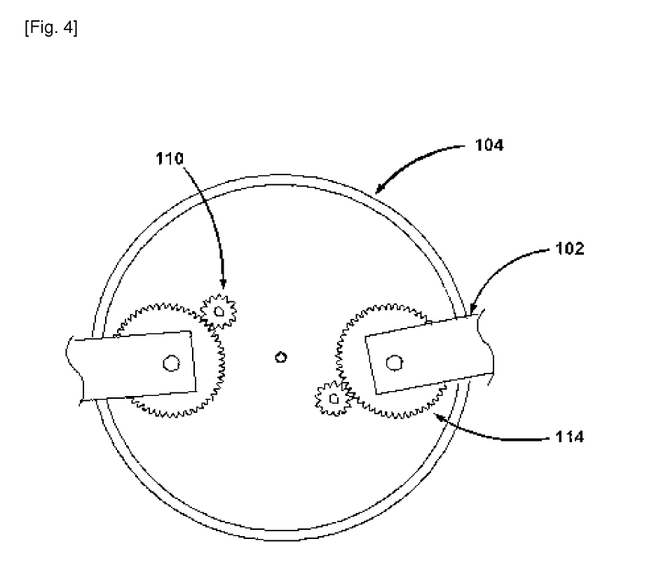

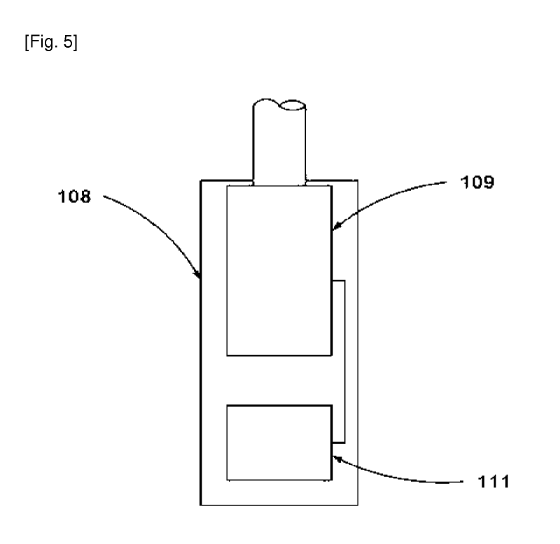

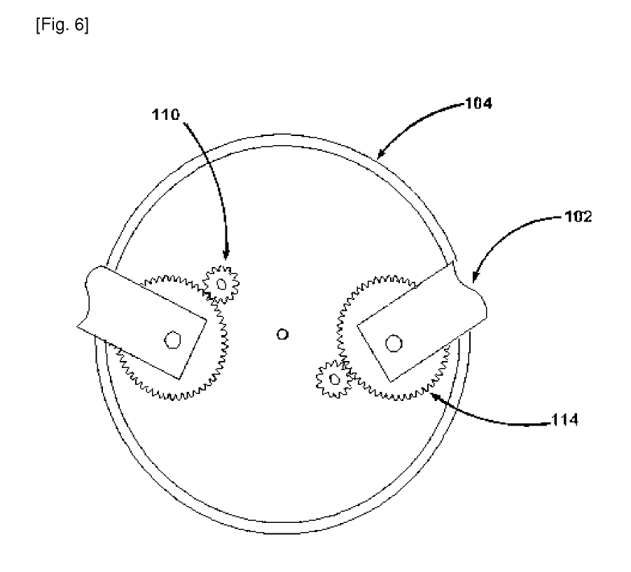

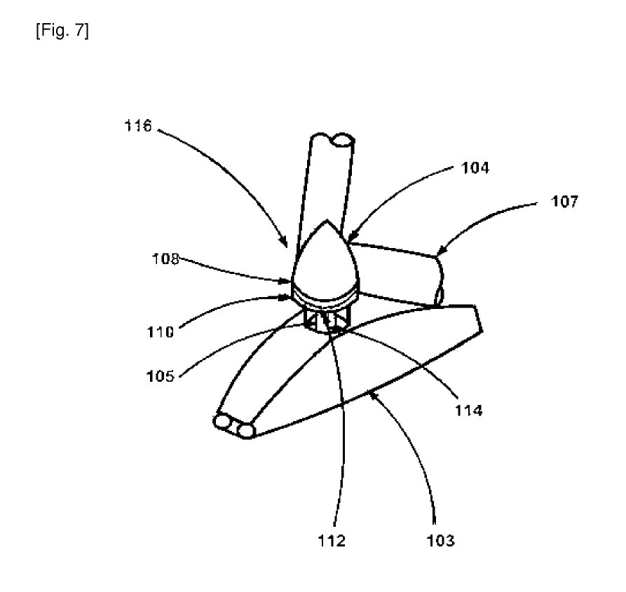

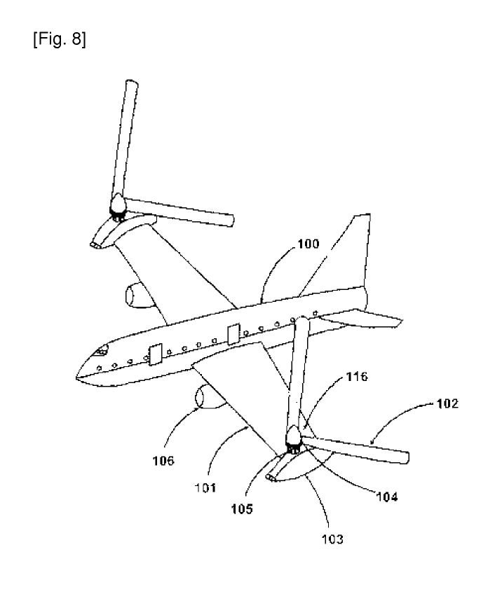

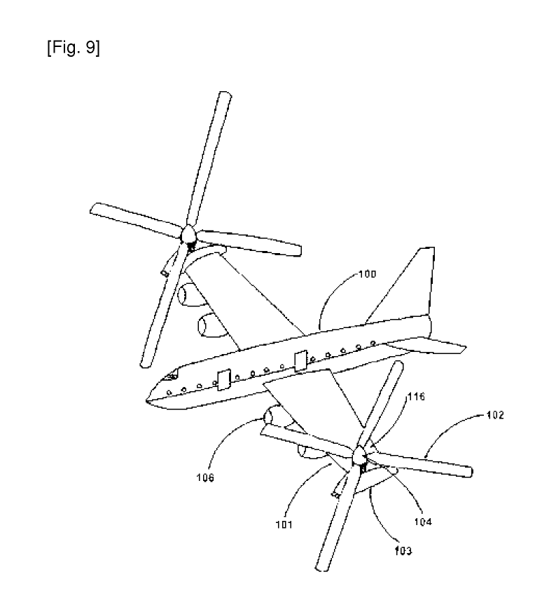

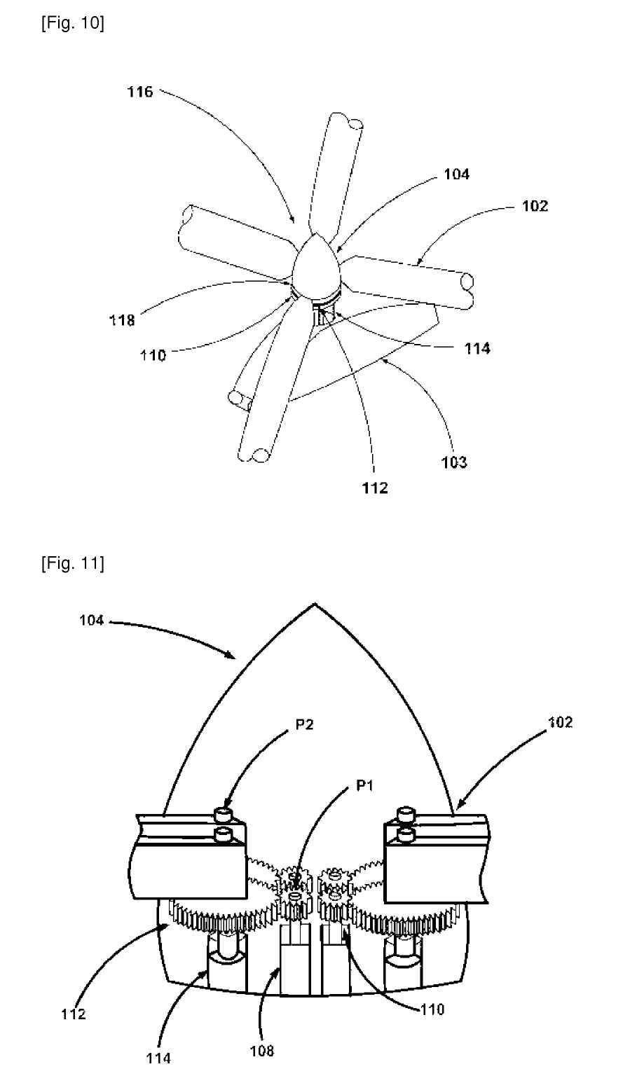

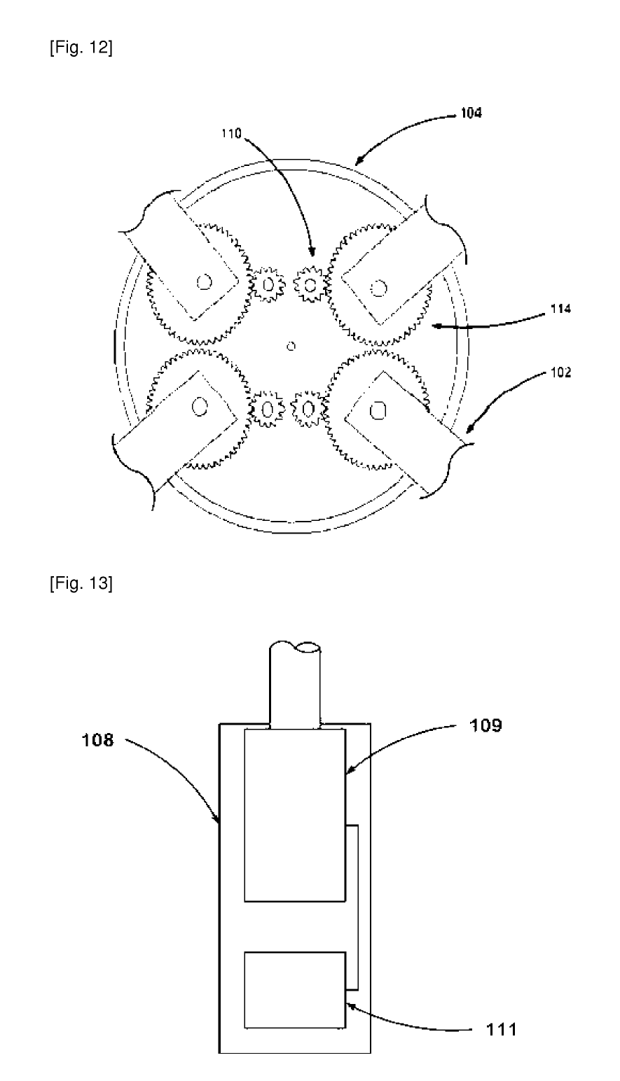

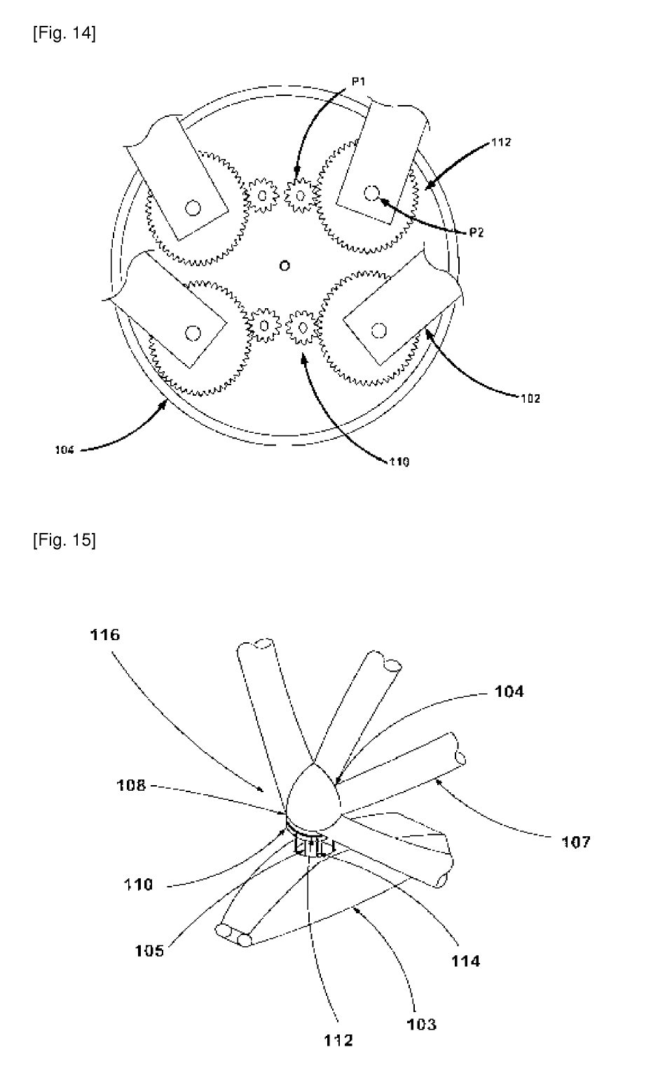

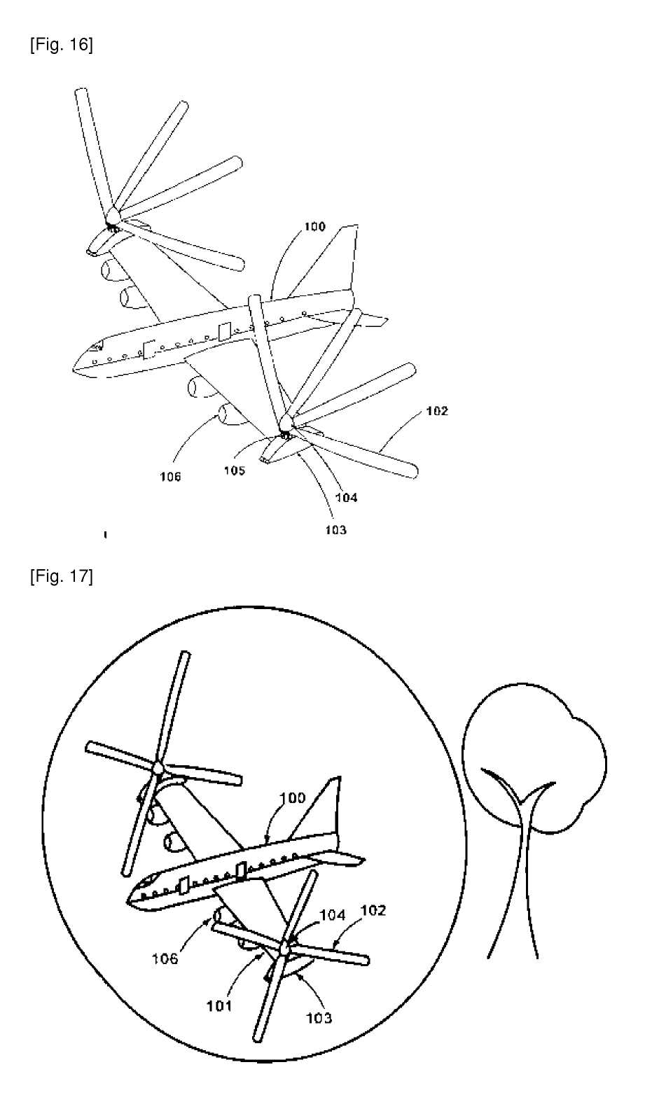

### BEST MODE FOR CARRYING OUT THE INVENTION

As illustrated in the figures, the entire composition of this invention is comprised of a flying body (100), the flying wings (101) mounted unmovably on the sides of the body (100), the rotary wings (102) which are rotated by the rotary wing engines (103) mounted on the sides of the above mentioned flying wings (101) and the rotary wing angle adjusting means (104) mounted on the center of the rotary wings (102).

The VTOL (100) rotates the rotary wings (102) to generate lift when taking-off; and when going forward, the lower swash plate (110) is tilted toward the front of the VTOL (100) by the hinge type rod (114) connected to the control device in the operating seat making the upper swash plate (108) connected with the lower swash plate (110) through the ball bearing (112) rotate in the tilted state and making the rotary wing angle adjusting means (104) mounted on the upper swash plate (108) rotate together in the tilted state and consequently the angle of attack of the wing mounted on the upper swash plate (108) is changed to produce thrust making the aircraft fly forward.

Also, when high speeds are necessary, the speed can be accelerated by operating the Wing-Mounted Pad jet engines (106) that are mounted beneath the main wings to reduce noises delivered to the operating seat or passenger seats and to enable easy maintenance and the rotary wings (102) are moved using the driving shaft (118) inside the rotary wing angle adjusting means (104) to adjust angles between the wings so that the angles of retreating can be adjusted like the way eagles retreat their wing backward when flying fast in order to reduce drag and increase lift; and inside the driving shaft (118) are the receiver and controller (128) that receive signals from the operating seat for control and inside the driving shaft (118) is also mounted to the servo motor (130) controlled by the receiver and controller (128) to produce rotating motive power in order to drive the pinions (120) mounted at the top end and then the pinions (120) fixed to the gear driving shafts (118) by pins (P1) are engaged with the gears (124) which are connected to the rotary wings (102) through the vertically moving shafts (122) which are fixed to the rotary wings (102) by pins (P2) so that they can adjust the distances between individual wings and using this structure, the rotary wings (102) are turned to make the angles of retreating wings become close to 0° when the speed is below the critical Mach so that the lifts of the wings on both sides are balanced while flying and when the speed is to go over the critical Mach, the angles of retreating wings are adjusted toward the opposite direction of flying like eagles retreating their wings backward when flying fast to prevent a rapid increase of the entire drag due to the increased wave-making drag created by the impact waves occurring when the speed reaches at Mach 1 while controlling the wings to generate the optimum lift and transforming them into a form of fixed wings (107) to enable flying at high speeds.

### MODE FOR THE INVENTION

When high-speed flight is desired, the location of jet engines on the nose has advantages in that clean airflow is provided without being affected by the body, but has disadvantages in that the intake vent located on the nose requires a very long internal duct that causes frictional losses, increases the weight, and takes up a great portion of the body space. The location of the jet engines on the chin has advantages in that the length of the internal duct can be shorter compared to the location on the nose and air inhalation can be smooth with the high receiving angle but it poses a problem in securing the location to install the Nose Landing Gear. Generally, the nose landing gear is installed right after the intake vent to hold the nose landing gear in the cowl of the intake vent. The side-mounted intake vents commonly found in dual-engine airplanes provide short duct lengths and relatively clean air flows but the problem of the swirling air flows separated from the fore-body flowing into the duct at a high receiving angle should be solved. The problem of swirling air flows flowing into the duct as such is especially serious when the fore-body is square. Some single-engine airplanes also use side-mounted intake vents, and in such cases, there should be two separated ducts laid up to the front of the engines to avoid the problem of pressure instability. The armpit intake vents installed at the locations where the body and the high wings are joined together can make the length of the internal ducts very short but there is a very high risk that the intake vents will sink into the thick boundary layer formed in the interface between the fore-body and the wings and it must be recognized that the flows will be greatly distorted at the high receiving angle and the side sliding angle. Over-fuselage intake vents are in the form opposite to that of chin intake vents and they have the advantage that they have very short duct lengths without the problem of the nose landing gear installation but have the disadvantage that their air inhaling performances are deteriorated at high receiving angles. Those intake vents located on the tail wings may produce the effect to separate the flow of the body and to reduce drag but they require special forms of ducts and they are subject to the potential that the boundary layer may flow into them. Those intake vents installed in the front side of wings do not require separate cowls thus the wetted area of the entire airplane may be reduced but they have the disadvantage that they will changes the flows passing the wings and will increase the weight of wings. Over-wing pad engines can reduce the height of landing gear and reduce noise on the ground but they have the disadvantage that they make service difficult. Installing pad engines on the rear-body may eliminate the interference of the air flows passing the wings and reduce the height of landing gears but the disadvantage is that it increase the amount of noise delivered to the riders sitting in the rear of the airplane. Also, since the weight center moves toward the rear, the overall position of the body should move forward relative to wings. This will in turn reduce the distance between the manipulated plane and the weight center (Moment Arm), ultimately requiring increased areas for the horizontal and vertical tail wings.

1. A VTOL aircraft (100) which is comprised of rotary wings (102) to create lift when taking off, rotary wings (102) which are fixed on the propeller angle adjusting units (104) to transform the rotary wings (102), the propeller angle adjusting units (104) which are fixed on the swash plate, the swash plate which can adjust the tilt angle to generate thrust how to control angle of attack of rotary wings(102) that change direction of lift from beneath aircraft to direction of flight rear when it flies at low speeds, the propeller angle adjusting units (104) which adjust the rotary wing angles to transform the rotary wings (102) into fixed wings away from the direction of flight like an eagle's wings that are pushed back at high speed, propeller angle adjusting units (104) to transform the rotary wings (102) into fixed wings (107), and jet engines (106) to efficiently generate thrust together with flying wings (101) for forward movements when the rotary wings (102) have been transformed into fixed wings (107) by the propeller angle adjusting units (104) that use variable rotary wings

2. In the above claim 1,
A VTOL aircraft that uses variable rotary wings (116) characterized by the configuration where the adjustment of the abovementioned propeller angle means (104) that it has internal drive-shafts (118) to generate the motive power that can adjust the retreating angles of the rotary wings (102) like an eagle's wings at high speed are held away from the direction of flight, to enable the aircraft to fly with efficiently balanced drag and lift when adjusting the angles between each of the rotary wings (102), drive-shafts (118) which are comprised of receivers and controllers (128) that receive signals from the operating seat to control the drive-shafts (118), servo motors (130) that are controlled by the receivers and controllers (128) to generate rotating motive power to drive the pinions (120), the adjusting means are configured to control and drive the servo motors (130) with the receivers and controllers (128) to drive the pinions (120) mounted on the top end of the shafts (118) so that the pinions (120) fixed to the gear drive-shafts (118) by pins (P1) are engaged with the gears (124) which are connected to the rotary wings (102) through the vertically moving shafts (122) which are fixed to the gear drive-shafts (118) by pins (P2) so that they can adjust the distances between individual wings, the propeller angle adjusting means (104) which is fixed on the upper swash plate (108) to enable the upper swash plate(108) to turn toward the angle of inclination of the lower swash plate(110), which is connected to the lower plate(110) by ball bearings to enable rotation in every direction, including up and down, the lower plate(110) which connects the load to the hinge to enable control by the controllers from the operating seat
